(19) United States
(12) Patent Application Publication
(10) Pub. No.: US 2021/0133824 A1
(43) Pub. Date: May 6, 2021

(54) SYSTEMS AND METHODS FOR GENERATING FORECAST DATA AND OPTIMIZING REAL-TIME ELECTRONIC BIDS ON IMPRESSIONS

(71) Applicant: AUDIENCE TOWN, LLC, Newark, NJ (US)

(72) Inventors: Edmund L. Carey, South Orange, NJ (US); Anthony D. Greco, Ho-Ho-Kus, NJ (US); Greg Cappello, Oyster Bay, NY (US)

(73) Assignee: AUDIENCE TOWN, LLC, Newark, NJ (US)

(21) Appl. No.: 16/714,632

(22) Filed: Dec. 13, 2019

Related U.S. Application Data
(60) Provisional application No. 62/928,154, filed on Oct. 30, 2019.

(51) Int. Cl. G06Q 30/02; G06Q 50/16; G06N 5/04

(52) U.S. Cl. CPC G06Q 30/0275; G06N 5/04; G06Q 30/0255; G06Q 50/16

(57) ABSTRACT

A system for generating forecast data and optimizing a real-time bid on an impression comprising a user information database and a processor in communication with the user information database. The processor receives input data that is indicative of a probability of a user to purchase or rent real estate from the user information database. The processor generates a purchase window that is indicative of a predetermined time period when the user is likely to purchase or rent the real estate for the user based on the received input data. The processor then automatically adjusts a bid for an impression in real-time based on the generated purchase window.

### RELATED APPLICATIONS

This application claims priority to U.S. Provisional Patent Application Ser. No. 62/928,154 filed on Oct. 30, 2019, the entire disclosure of which is incorporated herein by reference.

### BACKGROUND

### Technical Field

The present disclosure relates generally to the field of real-time electronic bidding technology. Specifically, the present disclosure relates to computer-based systems and methods for generating forecast data and optimizing real-time electronic bids on impressions.

### Related Art

Real-time bidding (“RTB”) is a computer-based technology wherein advertising inventory is bought and sold on a per-impression basis, via programmatic, instantaneous auctions that are carried out on an electric bidding platform. An impression occurs when an advertisement is obtained from a source, and is countable, regardless of whether the advertisement is clicked on by a user. Using RTB, advertising buyers bid on impressions; if the bid is won, the buyer's advertisement is instantly displayed on a publisher's website.

Managing real time bidding for real estate purposes can be challenging. This is because it is difficult to determine whether an individual is currently in the market to buy or rent a home or commercial property, and if so, in what time frame that transaction will occur. The bidding systems currently used to bid on the impressions price each particular bid based on whether a user meets a profile of a likely buyer of that product. The profile may be tied to cookies, which are browser-based files that anonymously identify various attributes of individual users of web browsers. However, cookies can fail to indicate when a user might buy a particular product. In the field of real estate, for example, this is a particular problem due to long purchase windows. Accordingly, prior art systems price a bid for a particular impression at the same amount, regardless of when a user is looking to buy or rent property. Therefore, there is a need for computer systems and methods which can determine a user's intent to purchase/rent real estate within a particular timeframe and automatically generate a correlating bid for an impression, thereby improving the ability of computer systems to more efficiently and effectively process bids in real time on advertisement space. These and other needs are addressed by the computer systems and methods of the present disclosure.

### SUMMARY

In one aspect, the present disclosure relates to computer-based systems and methods for generating forecast data and corresponding real-time bids on impressions. In one embodiment, the system receives input data which can include a user's offline behavior, online behavior, consumer characteristics (e.g., net worth, home size, etc.), life events regarding such individual (e.g., new child, graduation, marriage, death, divorce, etc.), among other data. The system then generates a forecast of a purchase window for the user using the input data, which indicates a time period when the user is likely to purchase or rent real estate. The system then processes the purchase window to optimize future bidding by users, thereby improving the efficiency and speed with which the system can process electronic bids on real estate. For example, the system can automatically increase a bid for a user (without requiring the user to manually monitor the bid and increase it) for impressions based on whether and where the user falls within the purchase window.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the overall system of the present disclosure;

FIG. 2 is a flowchart illustrating the overall process steps carried out by the system of the present disclosure; and

FIG. 3 is a diagram illustrating sample hardware and software components capable of being used to implement the system of the present disclosure.

### DETAILED DESCRIPTION

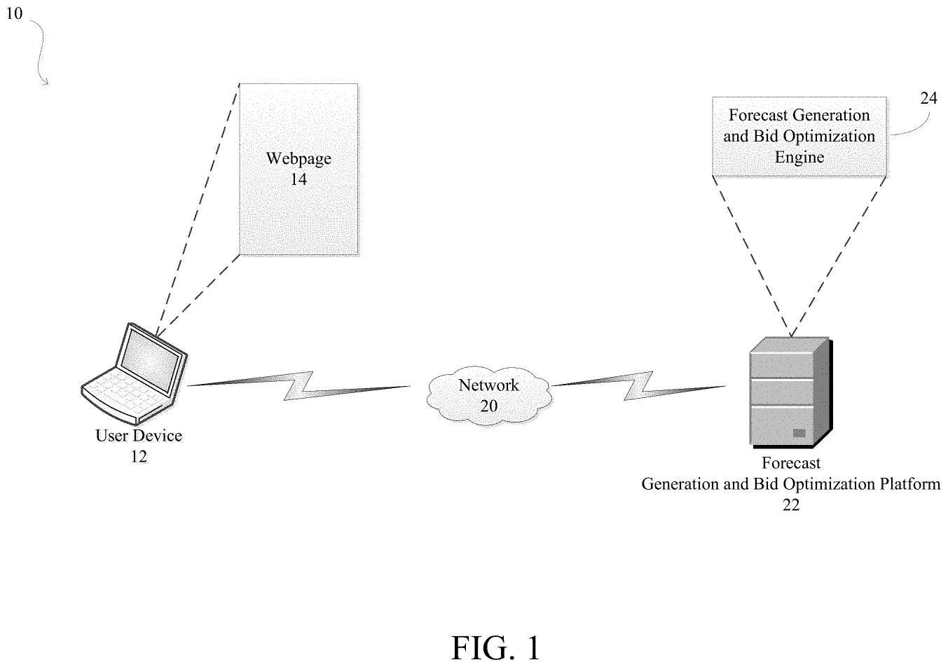

The present disclosure relates to computer-based systems and methods for generating forecast data and optimizing real-time electronic bids on impressions, as described in detail below in connection with FIGS. 1-3.

The system of the present disclosure describes a system capable of electronically predicting a user's intent to purchase real estate by receiving input data (“purchase window” indicators) of the user's offline behavior, online behavior, consumer characteristics (e.g., net worth, home size), and life events regarding such individual (e.g., new child, graduation, marriage, death, divorce). The system then processes input data and automatically increases/decreases a bid for an impression based on the purchase window, thereby resulting in more efficient and effective electronic processing of bids. For example, the number of potential buyers can be automatically decreased by the system when time approaches the transaction date. Moreover, the system can automatically increase the amount spent per user as the number of potential buyers decreases, until a purchase agreement is signed. As such, a system within the present disclosure represents an improvement in the speed and efficiency of bid processing of prior art systems by generating a prediction of whether and when the user is likely to purchase real estate, and automatically adjusting real-time bidding prices for advertisement space based on the prediction, thereby producing efficient and pertinent advertisements while efficiently managing costs of said advertisements (e.g., preventing overpayment for unqualified leads).

FIG. 1 is a diagram illustrating the system of the present disclosure, indicated generally at 10. The system 10 includes at least one user device 12, a network 20, and a forecast generation and bid optimization platform (computer system) 22. The user device 12 can be any electronic device such as a personal computer, a desktop computer, a tablet computer, a connected television, a digital-out-of-home product, a mobile phone, a smartphone, a phablet, an embedded device, a wearable device, a field-programmable gate array (“FPGA”), an application-specific integrated circuit (“ASIC”), etc. The user device 12 can connect to the Internet and load a webpage 14. The webpage can be any type of hypertext document connected to the World Wide Web. The forecast generation and bid optimization platform 22 can execute a forecast and bid generating engine 24, which is embodied as computer-readable instructions executed by the platform 22.

The user device 12 and the forecast generation and bid optimization platform 22 can further be connected to the network 20 such that the forecast generation and bid optimization platform 22 can receive data via the network 20 from the user device 12. The network 20 can be any type of wired or wireless network, including but not limited to, a legacy radio access network (“RAN”), a Long Term Evolution radio access network (“LTE-RAN”), a wireless local area network (“WLAN”), such as a WiFi network, an Ethernet connection, or any other type network used to support communication. For example, the user device 12 can be connected to the platform 22 via a wireless network connection (e.g., Bluetooth, WiFi, LTE-RAN, etc.). The platform 22 can be any type of server used for executing the forecast and bid generating engine 24. Alternatively, the engine 24 could be stored on and/or executed by a cloud-based computing platform, such as Amazon Web Services (AWS) or other suitable cloud-based platform.

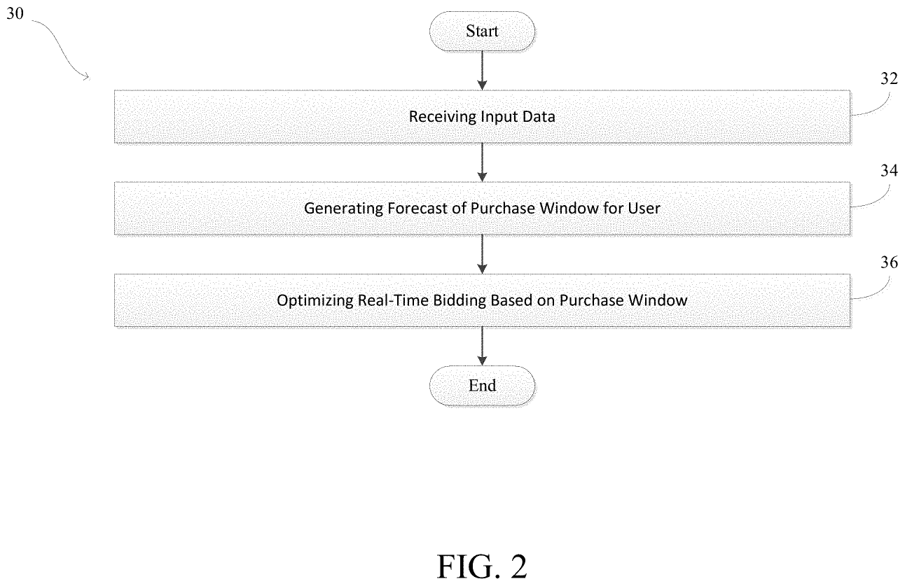

FIG. 2 is a flowchart illustrating overall process steps carried out by the system 10, indicated generally at method 30. In step 32, the system 10 receives input data. The input data (e.g., purchase window indicators) can comprise a user's offline behavior, online behavior, consumer characteristics (e.g., net worth, home size, etc.), life events regarding such individual (e.g., new child, graduation, marriage, death, divorce, etc.), among other data. More specifically, the input data can comprise listing data (e.g., from an application programming interface (“API”) feed), offline data (e.g., municipal data, database data, client data, etc.), first party data (e.g., user transactions, customer relationship management data (“CRM”) data, website data, content marketing data, etc.), second party data (e.g., user device 12 identification, user location, online behavior, etc.), third party data (e.g., cloud data, database data, credit data, etc.). In step 34, the system 10 generates a forecast of a purchase window for the user using the input data, wherein the purchase window comprises a time period when the user is likely to purchase or rent real estate. In step 36, the system 10 optimizes bids conducted on a real-time bidding system based on the purchase window generated by the system. For example, the system 10 can increase a bid for impressions based on whether and where the user falls within the purchase window.

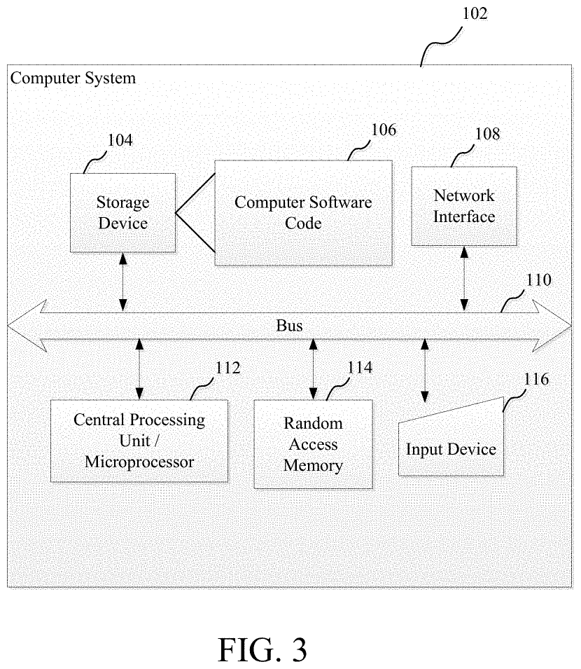

FIG. 3 is a diagram showing a hardware and software components of a computer system 102 in which the system of the present disclosure can be implemented. The computer system 102 can include a storage device 104, computer software code 106, a network interface 108, a communications bus 110, a central processing unit (CPU) (microprocessor) 112, a random access memory (RAM) 114, and one or more input devices 116, such as a keyboard, mouse, etc. The server 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The computer system 102 could be a networked computer system, a personal computer, a server, a smart phone, tablet computer etc. It is noted that the server 102 need not be a networked server, and indeed, could be a stand-alone computer system.

The functionality provided by the system of present disclosure could be provided by computer software code 106, which could be embodied as computer-readable program code stored on the storage device 104 and executed by the CPU 112 using any suitable, high or low level computing language, such as Python, Java, C, C++, C#, .NET, MATLAB, etc. The network interface 108 could include an Ethernet network interface device, a wireless network interface device, or any other suitable device which permits the server 102 to communicate via the network. The CPU 112 could include any suitable single-core or multiple-core microprocessor of any suitable architecture that is capable of implementing and running the computer software code 106 (e.g., Intel processor). The random access memory 114 could include any suitable, high-speed, random access memory typical of most modern computers, such as dynamic RAM (DRAM), etc.

Having thus described a system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A system for generating forecast data and optimizing a real-time bid on an impression, comprising:
a user information database; and
a processor in communication with the user information database, the processor:
receiving input data from the user information database, the input data being indicative of a probability of a user to purchase or rent real estate,
generating a purchase window for the user based on the received input data, the purchase window being indicative of a predetermined time period when the user is likely to purchase or rent the real estate, and
automatically adjusting a bid for an impression in real-time based on the generated purchase window.

2. The system of claim 1, wherein the input data comprises at least one of listing data, offline data, first party data, second party data, third party data, offline behavior of the user, online behavior of the user, consumer characteristics of the user and life events of the user.

3. The system of claim 2, wherein the consumer characteristics of the user comprises at least one of a net worth of the user, a credit history of the user, a desired real estate property type of the user, and a size of the desired real estate property type.

4. The system of claim 2, wherein the life events of the user comprises at least one of a new child, a graduation, a marriage, a death and a divorce.

5. The system of claim 1, wherein the system increases the bid for the impression based on the generated purchase window.

6. The system of claim 1, wherein the system decreases the bid for the impression based on the generated purchase window.

7. A method for generating forecast data and optimizing a real-time bid on an impression, comprising:
receiving input data indicative of a probability of a user to purchase or rent real estate;
generating a purchase window for the user based on the received input data, the purchase window being indicative of a predetermined time period when the user is likely to purchase or rent the real estate; and
automatically adjusting a bid for an impression in real-time based on the generated purchase window.

8. A non-transitory computer readable medium having instructions stored thereon for generating forecast data and optimizing a real-time bid on an impression which, when executed by a processor, causes the processor to carry out the steps of:
receiving input data from a user information database, the input data being indicative of a probability of a user to purchase or rent real estate;
generating a purchase window for the user based on the received input data, the purchase window being indicative of a predetermined time period when the user is likely to purchase or rent the real estate; and
automatically adjusting a bid for an impression in real-time based on the generated purchase window.

9. A system for generating forecast data and optimizing a real-time bid on an impression, comprising:
a user device; and
a processor in communication with the user device via a network, the processor:
receiving input data from the user device via the network, the input data being indicative of a probability of a user to purchase or rent real estate,
generating a purchase window for the user based on the received input data, the purchase window being indicative of a predetermined time period when the user is likely to purchase or rent the real estate, and
adjusting a bid for an impression in real-time based on the generated purchase window.

10. The system of claim 9, wherein the user device is one of a personal computer, a desktop computer, a tablet computer, a connected television, a digital-out-of-home product, a mobile phone, a smartphone, a phablet, an embedded device, a wearable device, a field-programmable gate array and an application specific integrated circuit.
